(19) United States
(12) Patent Application Publication
(10) Pub. No.: US 2007/0038717 A1
(43) Pub. Date: Feb. 15, 2007

(54) Customizable Content Creation, Management, and Delivery System

(75) Inventors: Christian K. Burkholder, Los Angeles, CA (US); Darren M. Kramer, Los Angeles, CA (US)

Correspondence Address: STEPTOE & JOHNSON LLP, 1330 CONNECTICUT AVENUE, NW, WASHINGTON, DC, 20036, US

(73) Assignee: SUBCULTURE INTERACTIVE, INC., Los Angeles, CA (US)

(21) Appl. No.: 11/460,224

(22) Filed: Jul. 26, 2006

Related U.S. Application Data
(60) Provisional application No. 60/703,231, filed on Jul. 27, 2005.

(51) Int. Cl. G06F 15/16

(52) U.S. Cl. 709/206

(57) ABSTRACT

A multimedia-enabled, customizable system for email and distributed rich media creation, management, and delivery is disclosed. The system includes: an email management server, web-animation and interface-enabled campaign sender device, and one or more recipient devices connected to the sender device and the email management server via a data communications network. The email management server is operatively connected to a mass storage device. The web-animation and interface-enabled campaign sender device enables a sender to create and send web-animation and interface-enabled campaign in conjunction with the email management server. The one or more recipient devices receive the web-animation and interface-enabled emails and distributed rich media. Preferably, the campaignsare generated in mass via a single generation process in a customizable manner that enables individualized email and distributed rich media tailoring to each recipient, wherein portions of the emails and distributed rich media are personalizable.

### CROSS-REFERENCE TO RELATED APPLICATIONS

This application claims the benefit of U.S. provisional patent application No. 60/703,231, filed Jul. 27, 2005, which is herein incorporated by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

This invention relates generally to a message delivery system and method, and more particularly, to a message creation, management, and delivery system and method.

### BACKGROUND OF THE INVENTION

Electronic mail (abbreviated as email) is a method of composing, sending, storing, and receiving messages over electronic communication systems. The term email applies both to the Internet email system based on the Simple Mail Transfer Protocol (SMTP) and to intranet systems allowing users within one company or workgroup collaboration organizations to communicate with each other. Often these workgroup collaboration organizations may use the Internet protocols for internal email service.

Due to the very low cost of sending email, the use of email for mass email campaigns is very attractive and cost efficient. However, mass email campaigns that are generic in format and/or untargeted in their distribution, are at best ineffective and at worst annoying to the email recipients. Some recipients may classify email-based marketing campaigns that are generic in format and/or untargeted in their distribution as spam (e.g., unsolicited commercial email). Since an email recipient directly bears the cost of delivery, storage, and processing, one could regard generic, undesired emails as the electronic equivalent of junk mail.

Accordingly, the need exists for large scale email communication techniques that are not generic in format and/or untargeted in their distribution. These techniques should be configured to provide the email recipients with information that the recipients are interested in receiving.

### SUMMARY OF THE INVENTION

Briefly, and in general terms, a preferred embodiment of the invention is directed towards a multimedia-enabled, individually-customizable email and rich media delivery system for providing increased response ratios. The system includes a web-animation and interface-enabled email and rich media delivery system that facilitates transmitting emails and/or distributed rich media campaigns to target devices using a web-animation and interface software as a front end user interface application. The emails and/or rich media campaigns are generated in mass via a single generation process in a customizable manner that enables individualized tailoring to each recipient. Preferably, portions of the campaigns are personalizable and capable of delivering sound, text, graphics, video, combinations thereof, or other types of distributed rich media via the emails.

According to one preferred embodiment, the web-animation and interface software is FLASH. Preferably, the web-animation and interface-enabled email opens and plays directly from the email application, rather than requiring a separate browser to be launched. The system further comprises a sniffer mechanism that assists in determining what applications are supported by a target recipient's email application, thereby enabling emails to be formatted and transmitted as a web-animation and interface-enabled email that is in a format which is likely to be supported by the target recipient's email application.

According to another aspect of a preferred embodiment, the system includes multiple web-animation and interface-enabled email formats, enabling the system to select a corresponding web-animation and interface software format that is likely to be supported by the recipient's email application. Typically, a web-animation and interface-enabled email that is delivered to a recipient contains various interactive components that may be interacted with by the email recipient. The interactive components may include MP3 audio files, video files, games, shopping carts, and combinations thereof. Additionally, recipient interaction with one or more of these interactive components is trackable. The tracked recipient interaction is transmitted to a central database and stored in association with the interacting recipient.

According to another aspect, the web-animation and interface-enabled email enables promotion of various contests. One of the various contests is a competitive contest that tracks user activities with the web-animation and interface-enabled email and awards points accordingly. In one such contest, at the end of a predetermined period in the competitive contest, the recipient with the most points wins one or more prizes. Typically, activities that award points to recipients are predetermined by the sender of the web-animation and interface-enabled email.

According to another aspect of a preferred embodiment, the system further includes a software plug-in module that enables web-animation and interface-enabled rich media email to synchronize with a multimedia player on a recipient's email application. Preferably, the multimedia player on the recipient's email application is WINAMP. In such an embodiment, the plug-in module enables a sender of the web-animation and interface-enabled email with an ability to push customized content, directly through WINAMP. Typically, the content includes messages, advertising, games, MP3 audio files, video files, and combinations thereof. In some embodiments, the plug-in module tracks recipient listening habits, that are recipient preferences, including the types of songs, artists, listening dates, listening times, and combinations thereof.

In another preferred embodiment, the multimedia-enabled, customizable email delivery system, includes: an email management server, web-animation and interface-enabled email delivery sender device, one or more recipient devices, and a data communications network. The email management server is operatively connected to a mass storage device. The web-animation and interface-enabled email delivery sender device enables a sender to create and send web-animation and interface-enabled email in conjunction with the email management server. The one or more recipient devices are connected to the sender device and the email management server via a data communications network. Preferably, the one or more recipient devices receive the web-animation and interface-enabled emails. The emails and rich media are generated in mass via a single generation process in a customizable manner that enables individualized email tailoring to each recipient, wherein portions of the emails are personalizable.

According to one aspect of a preferred embodiment, the server includes one or more software modules for providing various creation, management, and/or delivery email functionalities. Preferably, the one or more software modules include an upload/selection module, a multimedia management module, an email formatting module, a query response module, a tracking module, or combinations thereof. The upload/selection module enables an administrator or sender to create, upload, or select stored web-animation and interface software templates, multimedia files, personal messages, sender data, or combinations thereof, for generation of the web-animation and interface-enabled emails. The email formatting module enables generation of appropriate email output based on selected or uploaded data. The multimedia management module assists with management of multimedia associated with the web-animation and interface-enabled emails. The query response module receives data requests from a recipient who is viewing and interacting with the web-animation and interface-enabled emails, retrieves the appropriate content, and streams the content to the recipient. The tracking module receives and tracks interactions with the web-animation and interface-enabled emails, including whether emails have been viewed, whether emails have been forwarded, whether interactive components of the FLASH campaign have been interacted therewith, and combinations thereof.

According to another aspect of a preferred embodiment, the emails enable delivery of sound, text, graphics, video, or combinations thereof. In one embodiment, the data communications network is a public Internet. Typically, the recipient devices have a web-animation and interface-enabled plug-in module installed for enabling display of web-animation and interface software content. Preferably, the web-animation and interface-enabled plug-in module is a FLASH player.

In another aspect of a preferred embodiment, the mass storage device is a disk drive that enables storing information used by the server. Preferably, the mass storage device maintains different web-animation and interface-enabled templates that are selectable by the sender to facilitate generation of the web-animation and interface-enabled emails. Additionally, the mass storage device includes various multimedia components that are selectable by the sender to facilitate generation of the web-animation and interface-enabled emails. Preferably, the selecting of the multimedia components is performed using “drag and drop” functionality. Additionally, the mass storage device stores one or more rules in a rules database that are useable by the email formatting module for determining an email output format to be used in transmitting the emails to indicated recipients.

In accordance with another aspect of a preferred embodiment, the sender and recipient devices are connectable to the data communications network using a telephone connection, a satellite connection, a cable connection, a radio frequency communication, a wired data communication mechanism, a wireless data communication mechanism, or combinations thereof. The sender and recipient devices include, by way of example only, and not by way of limitation: a personal computer, a hand-held personal computer, a television set top-box combination, a personal digital assistant, a mobile phone, or other comparable consumer electronics device. The platform to which the web-animation and interface plug-in module is installed, includes by way of example only, and not by way of limitation: LINUX, UNIX, MICROSOFT WINDOWS, MACINTOSH, WINDOWS MOBILE, WINDOWS CE, POCKET PC, SMARTPHONE, IRIVER, APPLE MACROS, and other mobile platforms. The data communications network is selected from the group consisting of: digital cable interactive television networks, digital subscriber lines, fiber-optic networks, interactive satellite television networks, and combinations thereof.

In another aspect of a preferred embodiment, the server is accessible through the use of a secure login and password. Preferably, the web-animation and interface-enabled emails contain unique variable identifiers that determine proper components and data for each email recipient. These include personalized data and multimedia components. Typically, a unique identifier is sent across the data communications network to the server and a query is performed on the mass storage device in response to an email recipient viewing the web-animation and interface-enabled email. The mass storage device accesses a unique identifier number and returns corresponding data to the recipient's web-animation and interface-enabled email. Preferably, the corresponding data includes personalized text data, MP3 audio data, video data, and combinations thereof.

According to still another aspect of a preferred embodiment, a scripting language pre-loader compiles data in a recipient's web-animation and interface software plug-in module, and displays the data as specified by a sender of the web-animation and interface-enabled email. The files that are useable with a template include multimedia files and web-animation and interface-enabled modules. Additionally, the system enables an administrator to securely login, to the system and view, add, delete, and modify modules and content. The system enables an administrator to assign access rights for various modules and components to one or more clients. The system enables an administrator to manage, edit, and delete users and user security levels. The system enables an administrator to add, delete, and edit global and user-specific reports and contest types. The system enables an administrator to add, delete, edit, and review individual campaign files and results.

According to yet another aspect of a preferred embodiment, the system further comprises an email grooming system, wherein the email grooming system examines an email addresses list to verify that all email addresses contain proper format and that no duplicate addresses exist. The email grooming system prevents an email recipient from using the system for nefarious practices. The server includes a secure login module, an upload module, an input handler module consisting of temporary data storage, a security checking module, a query response data module, a multimedia management module, a file error checking module, an update test module, a compression module, or combinations thereof.

According to another aspect of a preferred embodiment, the FLASH email opens and plays directly from the email application. A separate browser need not be invoked to open and play the FLASH email. A “sniffer” mechanism allows the email to be formatted and transmitted as a FLASH email if the recipient's email application is likely to support FLASH. If the recipient's email application is unlikely to support FLASH, a separate email format is used.

According to another aspect of a preferred embodiment, a recipient interacts with various interactive components of the FLASH campaign. For example, the FLASH campaign may include MP3 audio files, video files, games, shopping carts, and the like. Interaction with one or more of these components is tracked, and the tracking information transmitted to a central database and stored in association with the interacting recipient.

In another embodiment, the email campaign is for promoting different contests. One particular type of contest is a competitive contest that tracks user activities with the FLASH email and awards points accordingly. At the end of a predetermined period, recipients with the most points win prizes. The type of activities that will award points is predetermined by the sender during the email campaign setup.

According to another aspect of one embodiment, a plug-in allows the Rich Midia FLASH to be synchronized with WINAMP. The plug-in gives the sender the opportunity to push customized messages, advertising, games, and the like, directly through WINAMP. The plug-in further tracks user listening habits such as the types of songs, artists, listening dates/times, and the like.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 illustrates a schematic block diagram of an email creation, management, and delivery system, according to one embodiment;

FIG. 2A illustrates an exemplary web-animation and interface-enabled email that is sent as part of a larger email campaign, according to one embodiment;

FIG. 2B illustrates content that is displayed upon the selection of the email, according to one embodiment;

FIG. 2C illustrates interactive content within the web-animation and interface-enabled email, according to one embodiment;

FIG. 2D illustrates data streamed by the query response module upon selection of a button, according to one embodiment;

FIG. 3 illustrates a flow diagram of a process executed by one or more server modules for implementing a mass email campaign;

FIG. 4 illustrates a flow diagram of a process executed by one or more server modules for implementing a mass email campaign that is more detailed in the process shown in FIG. 3;

FIG. 5 illustrates a more detailed flow diagram of the various processes of FIG. 4;

FIG. 6 illustrates a flow diagram of the various processes that enable control of a template form;

FIG. 7 illustrates a flow diagram of the various processes that enable administration of contests;

FIG. 7A illustrates a flow diagram of the various processes that enable administration of users fields;

FIG. 8 illustrates a flow diagram that is similar to the process of FIG. 5, but includes functionality to analyze loan details; and

FIG. 9 illustrates a flow diagram that is similar to the process of FIG. 5, but is specific to the use of mobile devices to retrieve and view the emails.

### DETAILED DESCRIPTION OF THE PREFERRED EMBODIMENTS

In a preferred embodiment of the invention, a multimedia-enabled, individually-customizable email delivery system is configured to enable creation, management, and delivery of web-animation and interface-enabled emails, while providing increased response ratios. The system includes a web-animation and interface-enabled email delivery system that facilitates transmitting emails to target devices using web-animation and interface software as a front end user interface application. Preferably, the emails and rich media are generated in mass via a single generation process in a customizable manner that enables individualized email tailoring to each recipient. In this manner, portions of the emails are personalizable and capable of delivering sound, text, graphics, video, or combinations thereof.

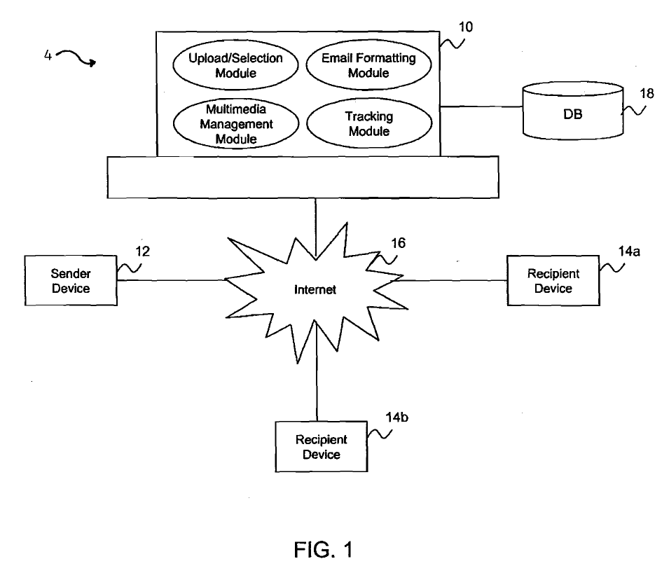

Referring now to the drawings, wherein like reference numerals denote like or corresponding parts throughout the drawings and, more particularly to FIGS. 1-5, there are shown various embodiments of a system 4 for a multimedia-enabled, customizable email delivery system. The system 4 includes: an email management server, a web-animation and interface-enabled email delivery sender device, one or more recipient devices 14, and a data communications network 16.

The email management server is operatively connected to (or includes) a mass storage device. The web-animation and interface-enabled email delivery sender device 12 enables a sender to create and send web-animation and interface-enabled email in conjunction with the email management server. The one or more recipient devices 14 are connected to the sender device 12 and the email management server via a data communications network 16. Additionally, the one or more recipient devices 14 receive the web-animation and interface-enabled emails. The emails and rich media are generated in mass via a single generation process in a customizable manner that enables individualized email tailoring to each recipient. Specifically, portions of the emails are personalizable.

In general terms, the invention is directed to a web-animation and interface software (e.g., FLASH) enabled email campaign that dramatically increases response ratios while reducing campaign costs and efforts. The email campaign transmits mass emails to target devices using web-animation and interface software as a front end software application (e.g., FLASH or other equivalent application). The selected web-animation and interface software is preferably bandwidth friendly, browser independent, and vector-graphic based animation technology. Although the emails and rich media are generated in mass via a single campaign setup process, certain portions of the mails are nonetheless personalized so that sound, text, graphics, and/or video are deliverable in a fashion that is unique to each recipient. As used herein, the term “sender” indicates an individual or organization sending a campaign through the administrative module. Additionally, the term “recipient” indicates an individual or organization receiving a campaign through an email client or equivalent delivery platform.

FIG. 1 is a schematic block diagram of an email campaign system 4 according to one embodiment of the invention. The system 4 includes a server 10 coupled to a sender device 12 and various recipient devices 14a-14b over a data communications network 16 such as, for example, a public Internet. The recipient devices 14 have at least a web-animation and interface software plug-in installed, such as, for example, a Macromedia FLASH player, for enabling the display of web-animation and interface software content.

The server 10 includes one or more software modules for providing different mass email campaign functionalities. Such software modules may include an upload/selection module for allowing an administrator or sender to create, upload, and/or select stored web-animation and interface software templates, multimedia files, personal messages, sender data, and the like, for generating the email campaign. The software modules may also include an email formatting module for generating an appropriate email output based on the selected/uploaded data. A query response module receives data requests from a recipient viewing and interacting with the email campaign, retrieves the appropriate content, and streams the content to the recipient. A tracking module receives and tracks interactions with the email campaign, including whether the email has been viewed, whether the email has been forwarded, and other interactions with interactive components provided by the email campaign.

The server 10 is also coupled to a mass storage device 18 such as, for example, a disk drive or drive array, for storing information used by the server 10 for providing the mass email campaign functionalities. For example, the mass storage device may maintain many different web-animation and interface software templates that the sender may select from in generating the email campaign. The mass storage device may also include different multimedia components that the sender may choose to include in the campaign. Furthermore, the mass storage device may store in a rules database, different rules used by the email formatting module for determining the email output format to be used in transmitting the email campaign to an indicated recipient. The rules may indicate whether a recipient's email application is likely to support the selected web-animation and interface software.

According to one preferred embodiment, the web-animation and interface enabled email opens and plays straight from the email application. Otherwise stated, a separate browser need not be invoked to open and play the web-animation and interface enabled-email. A “sniffer” mechanism allows the email to be formatted and transmitted as a FLASH email if the recipient's email application is likely to support FLASH. If the recipient's email application is unlikely to support FLASH, a different web-animation and interface software email format is used.

In another aspect of a preferred embodiment, a recipient interacts with various interactive components of the web-animation and interface software objects. For example, the web-animation and interface software objects may include MP3 audio files, video files, games, shopping carts, and the like. Interaction with one or more of these components may be tracked, and the tracking information transmitted to a central database and stored in association with the interacting recipient.

In one preferred embodiment, the email campaign is for promoting different contests. One particular type of contest is a competitive contest that tracks user activities with the FLASH email and awards points accordingly. At the end of a predetermined period, recipients with the most points win prizes. The type of activities that will award points is predetermined by the sender during the email campaign setup.

Continuing, in another aspect of a preferred embodiment, a plug-in module allows the web-animation and interface software to be synchronized with WINAMP (or with another equivalent media player). The plug-in module gives the sender the opportunity to push customized messages, advertising, games, and the like, directly through WINAMP (or with another equivalent media player). The plug-in module further tracks user listening habits such as the types of songs, artists, listening dates/times, and the like.

In a preferred embodiment, the sender and recipient devices 14 may connect to the data communications network 16 using a telephone connection, satellite connection, cable connection, radio frequency communication, or any wired or wireless data communication mechanism known in the art. To this end, the devices may take the form of a personal computer (PC), hand-held personal computer (HPC), television and set top-box combination, personal digital assistant (PDA), cellular phone, or any consumer electronics device known in the art.

The system 4 can be run on any platform for which there is a Macromedia FLASH plug-in module. To date, these include LINUX, UNIX, MICROSOFT WINDOWS (all versions), MACINTOSH (all versions), WINDOWS MOBILE, WINDOWS CE, POCKET PC, SMARTPHONE, IRIVER, APPLE MAC OS, and other mobile platforms. The system 4 is expandable to support future platforms as they come available.

A preferred embodiment of the system 4 runs on both private networks, as well as the Internet. Other preferred embodiment of the system 4 have the ability to run over digital cable interactive television networks, fiber-optic networks and/or interactive satellite television networks that support Macromedia FLASH, or another operationally equivalent web-animation and interface-design software.

According to one embodiment, a client computer 12 operated by a sender is connected to a network 16, which is usually the Internet, but can be one or more local area networks or one or more wide area networks. A multi-module database lies on a server 10 to which the client computer 12 connects through a secure login and password. The client computer/sender 12 creates a new email campaign by choosing existing templates (e.g., FLASH templates) installed in the system (by an administrator) and sends mass emails to target remote computers (recipients) 14.

The mass emails and distributed rich media contain a unique variable ID (i.e., identifier) that determines all of the proper components and data for each recipient. This consists of personalized data and multimedia components chosen by the sender during campaign setup. As the emails are being sent, the database on the server 10 determines which recipient email clients 14 support the FLASH (or equivalent web-animation and interface software) plug-in module based on predetermined rules (set by an administrator). Recipients with email clients that the database determines have a high probability of viewing FLASH inside the client are sent an HTML email with a remote FLASH “shell” file embedded. Recipients with email clients that the database determines have a low probability of viewing the FLASH plug-in module directly in their email are sent an alternative HTML email (specified by the sender in campaign setup). These HTML email are sent with the mime email header type multipart/alternative. This mime type is an email standard as defined by the World Wide Web Consortium (W3.org). This mime type relays to an email client what content to show in the headers of an email. The email client displays HTML content if the email client supports HTML and text only if the email client does not support HTML.

When a recipient views the web-animation and interface-enabled email or distributed rich media, the unique ID (i.e., identifier) is sent across the Internet to the remote server 10 and a query is performed on the database 18. The database 18 looks up the unique ID number sent by the client and returns relevant data to the recipient's FLASH plug-in module inside their email. This relevant data consists of personalized text data, MP3 audio, FLV video, include SWF files and AS code files. A script language pre-loader (e.g., actionscript) compiles all of this data in the recipient's plug-in module, then displays the data as specified by the sender in the original campaign setup. Once a recipient has viewed the web-animation and interface-design software file, a second variable is sent to the database 18 on the server 10 that the web-animation and interface-enabled email has been viewed by that user.

The system 4 can support the requirements of many different media formats and output players including, by way of example only, and not by way of limitation: FLASH SWF, FLASH FLV, FLASH AS, XML, MICROSOFT SQL, MICROSOFT NET ASPX, PHP, MYSQL, MICROSOFT ASP, JAVA, ORACLE, MICROFSOFT SPARKLE, COLDFUSION CFM, TEXT TXT, HTML, XHTML, CSS, SMIL, SGML, JSP, FLASH EXECUTABLE, EXECUTABLE PLUG-IN for WINAMP, PROPRIETARY FLASH, AUDIO XML FLASH, ANIMATION XML FLASH, SQL NET FLASH, FLASH XML supporting HTML/DHTML, ANIMATION XML, FLASH SUPPORTING DATABASE PRESENTATION, FLASH AUDIO XML FLASH with AUDIO, FLASH AUDIO XML HTML/DHTML PRESENTATION, WEB-BASED EMAIL supporting FLASH, MICROSOFT OUTLOOK/OUTLOOK EXPRESS supporting FLASH, ENTOURAGE supporting FLASH, POPS EMAIL supporting FLASH, IMAP EMAIL supporting FLASH, SMTP EMAIL supporting FLASH, MAPI EMAIL supporting FLASH, EXCHANGE SERVER supporting FLASHOO, SALESFORCE.COM EMAIL supporting FLASH, PRESENTATION, XML FLASH with ANIMATIONS, MP3 AUDIO, WAV AUDIO, FLASH, AUDIO INFORMATION, PRESENTATION FORMAT HTML/DHTML, FLASH with MULTIPLE AUDIO RATES, FLASH for PDA, FLASH for PDA EMAIL, FLASH for MOBILE DEVICES & PHONES, FLASH for MOBILE DEVICES and PHONES through EMAIL, FLASH for MOBILE DEVICES and PHONES through INTERNET EXPLORER, and the like.

According to one embodiment of the invention, the system rules determine probability of an output file being sent to a mobile device or major web-based email system (YAHOO, GMAIL, HOTMAIL, and the like). In these occasions, alternative versions of the output files are referenced to optimize the experience for the appropriate platform (one or more for mobile devices, one alternative for web-based email).

According to one embodiment of the invention, a customer of the service/product (sender) goes to a proprietary website through a direct connection, the Internet, or any other suitable connection and logs in using a secure user name and password. After the sender is connected to the website, a HTML based web page with associated scripts (ASPX, PHP, .JSP, and the like) is loaded onto the sender's computer. This page allows a sender to upload an amount of personalization data to be integrated into the system and further use the uploaded data to interact with the system. This data will either be in the form of a structured data file (.CSV, XLS, and the like) or alternatively, the data can be entered into the database 18 manually through a form.

The type of files that may be used with the template include multimedia files (MP3, MP4, QUICKTIME Video (QT), WINDOWS MEDIA VIDEO (WMV), FLASH Video (FLV), MPEG videos, as Actionscript files), and FLASH modules (games, shopping carts, personal messages, sender data, recipient data, electronic greeting cards, animated characters, text, text effects, website templates).

The data files, media templates and any other files are uploaded from the sender's computer through the Internet to the temporary data storage. This is temporary until the sender has previewed and approved the final output file. Upon approval, the output files are rendered to a permanent location on the server 10.

According to one embodiment of the invention, an administrator manages the various modules of the server 10. In this regard, an administrator has the ability to login as well as add, delete, and/or modify modules and content. These would consist of the list of files above. The administrator can assign rights to clients or groups of clients to access various modules and components. Additionally, an administrator can manage, edit, and/or delete users and security levels for users. Furthermore, an administrator can add, delete, and/or edit global and user-specific reports and contest types. Moreover, an administrator can add, delete, edit, and/or review individual campaign files and results.

A preferred embodiment of the customized message delivery system 4 includes an email grooming system. By incorporating an email grooming system, the relevant email list is checked to make sure that all of the email addresses contain proper format and there are no duplicate addresses when a sender executes a campaign. According to one embodiment, the email grooming system verifies that all email servers in the campaign list to ensure that the servers are running. This occurs when the sender executes the launching of the campaign.

When a recipient has “opted in” to a contest, they have the ability to forward the mail to other users using the server's sendmail program. To reduce the ability of the recipient to use the system for nefarious practices, they are only allowed to send mail from the email address they used to sign up. In addition, they can only forward the mail to a unique email address one time. Likewise, if another recipient that has signed up for the contest has sent a mail to an email address, then another recipient attempts to send a mail to that same address, they are blocked from doing so. This is required for every contest and takes place throughout the contest when recipients that have opted-in to the contest forward the mail.

According to one embodiment of the invention, the server 10 includes a secure login module, an upload module, an input handler module consisting of temporary data storage, a security checking module, a query of recipient data module, a multimedia management module, a file error checking module, an update test module, and a compression module. The input handler module can break down other information such as text or graphics that is input by the end user, which can be later integrated and compiled into the personalized output file.

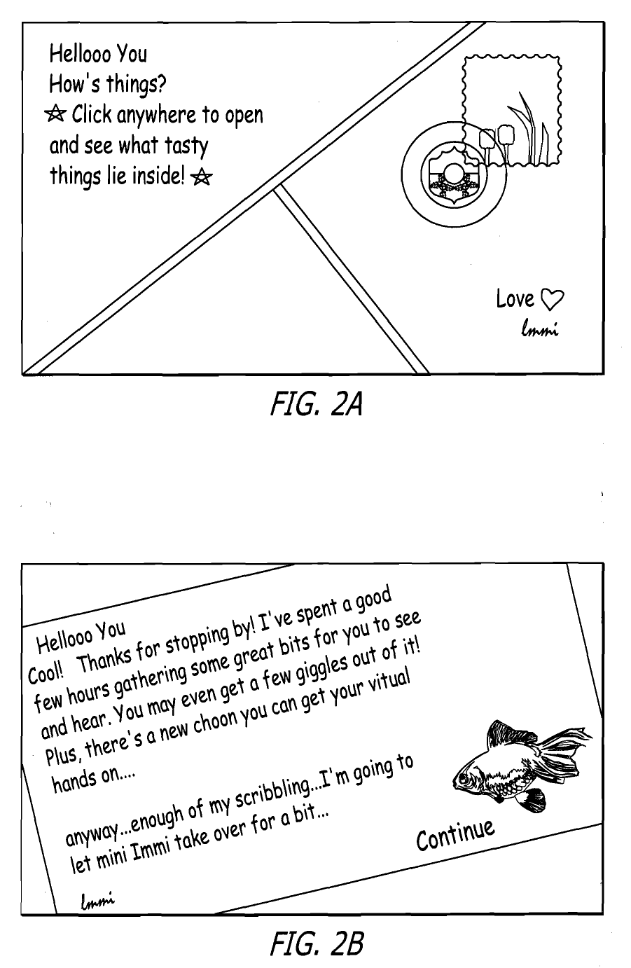

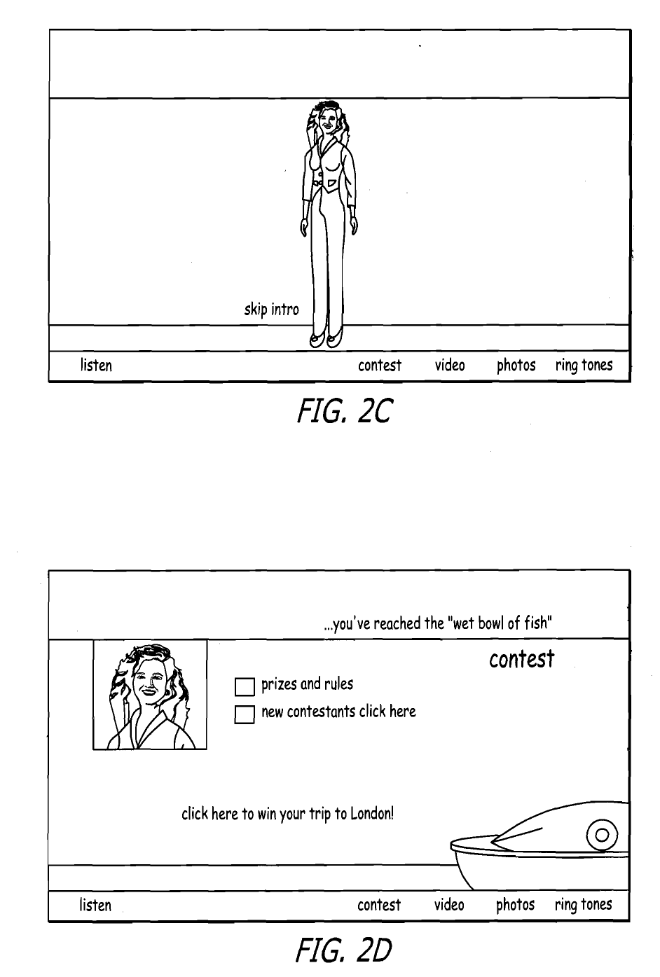

FIGS. 2A-2D illustrate an exemplary FLASH (or other equivalent web-animation and interface software) email that may be sent as part of an email campaign according to one embodiment of the invention. If the recipient supports FLASH, the FLASH email is played directly from the email application. Furthermore, aspects of the email are customized for the recipient. For example, the recipient may be addressed on the email via his or her name. The recipient opens the FLASH email by selecting any portion of it. Upon the selection of the email, content such as content illustrated in FIG. 2B is displayed.

As illustrated in FIG. 2C, the recipient may interact with the FLASH (or other equivalent web-animation and interface software) email by selecting a contest menu item to participate in a contest, a video menu item to view a video, a photos menu item to view photos, and the like. The recipient may also interact with the FLASH email to purchase products from an online retailer. Upon selection of one of these menu items, a request is transmitted to the query response module with a unique ID assigned to the email. Upon receipt of the request, the query response module retrieves the requested data from the mass storage device, and streams the data to the requesting device.

FIG. 2D illustrates data streamed by the query response module upon selection of the contest button. To enter the contest, the recipient registers himself as a contestant upon selecting a registration button. If the contest is a send-to-a-friend competition, a registered contestant forwards the FLASH (or other equivalent web-animation and interface software) email to as many people as possible and earns points upon a predefined interaction by the forwarded recipient, such as, for example, the opening of the FLASH email. The tracking module tracks the interactions from the different recipients and credits the points to the appropriate person.

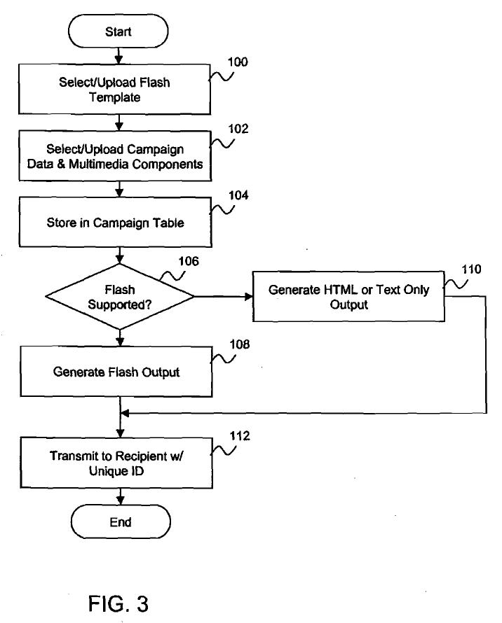

FIG. 3 is a flow diagram of a process executed by one or more server modules for implementing a mass email campaign according to one embodiment of the invention. In step 100, a campaign creator uploads or selects a web-animation and interface software (e.g., FLASH) template to be used for the email campaign. According to one embodiment, the FLASH template includes embedded merge fields for merging campaign data selected by the campaign creator to generate a customized campaign.

In step 102, the campaign creator uploads to the server 10, personalized data and/or multimedia components for the campaign. The campaign creator further defines other features of the FLASH campaign, such as, for example, the placement of text, the menu titles to be included, the video and audio content and order, type of games, and the like. If a contest is to be promoted via the campaign, the campaign creator chooses the type of contest from a list of pre-built contests, and sets the various parameters for the contest, such as, for example, the contest duration, prizes, contestant actions that are to be monitored, and the like.

In step 104, the upload and other campaign setup data is stored in a campaign table of the server's mass storage device, more specifically, in one or more standard and/or custom fields. The campaign creator may later access the campaign table to modify, add, or delete data contained in the one or more fields. Once the campaign creator is ready to send the email campaign, he or she transmits a command to this respect, and in response, the server's email formatting module is invoked to generate the emails that are to be transmitted to the various recipients, in the appropriate output format.

According to one embodiment of the invention, the email-formatting module generates a different email output based on a determination as to the likelihood that a particular recipient will be able to view FLASH (or other equivalent web-animation and interface software) animation within the recipient's email application. This may be done, for example, by examining the recipient's email address. If the recipient uses YAHOO, AOL, or MAIL.com, the email output is an HTML version only that includes a query string image and link. The link is to a dynamic middleware file with the embedded FLASH template selected by the campaign creator. If a user uses MAC.com or other email application that supports embedded FLASH, an HTML email that provides the full FLASH experience is sent.

Thus, in step 106, the email formatting module determines, based on a comparison of the recipient's email with rules stored in the rules database, whether the recipient is likely to support FLASH (or other equivalent web-animation and interface software). If the answer is YES, an HTML email is generated in step 108, with the FLASH (or other equivalent web-animation and interface software) template embedded in it. Otherwise, an HTML or text-only email is generated in step 110.

In step 112, the email is transmitted to the recipient in the determined output format, with a unique ID (i.e., identifier) associated with the email. As the recipient views the web-animation and interface-enabled email, either directly from the email application or from a separate browser, the email recipient's unique ID is transmitted to the server 10 and a query is performed to retrieve the campaign content. The campaign content is returned to the web-animation and interface software plug-in module for merging it into the template. Once a recipient has viewed the web-animation and interface-enabled email, a second variable is sent to the server 10 to indicate that the campaign has been viewed by the recipient. Other interactions with the web-animation and interface-enabled email may also be monitored.

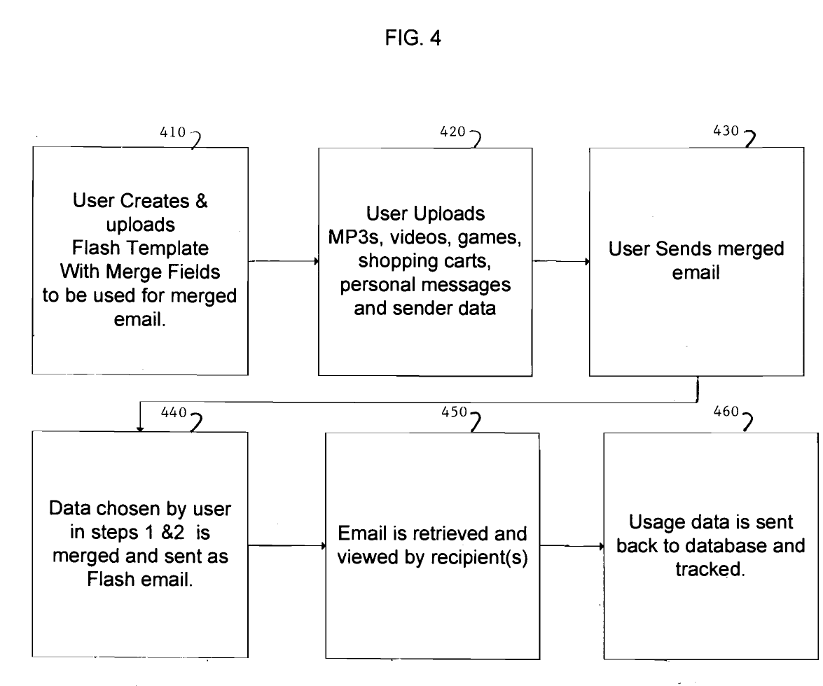

Referring now to the flow charts marked as FIGS. 4-9, embodiments of the invention includes a method for inputting data from a file or from a sender; converting the data into one or more pre-selected formats; and integrating the formatted data file into individual personalized digital media files templates that can be used interchangeably with other existing software applications and standards.

With reference to FIG. 4, in Step 410, an administrator or sender creates and uploads a FLASH (or other equivalent web-animation and interface software) template with embedded merge fields to be used for generating a merged email. In Step 420, the sender then uploads MP3 audio files, video files, games, shopping carts, personal messages, and sender data. The information may be uploaded into a database, such as, for example, an SQL database. The sender then may sort the information before continuing. The information can be saved into a new campaign table or merged with an existing campaign table.

According to one embodiment of the invention, the sender may specify: (1) Frame Rate; (2) Fonts, Font Size, Color Pre-formatted text effects (library) Upload JPG and PNG images; (3) Resize images; (4) Color effects (RGB+alpha) on images; (5) Choose text fields from pre-determined field list Move placement of text fields on page; (6) Modules (to appear as menu titles in admin tool): Audio, Video, Games, Contest, Custom Content; (7) Audio—upload MP3s and choose order of play; choose from array of MP3 player designs; (8) Video—Upload QUICKTIME, FLV and /or MPEG video clips. In the case of QT or MPEG, convert to FLV on the fly. Determine order of play; choose from array of video player designs; (9) Games—Choose from pre-built menu of games; and (10) Contests: (a) Choose type of contest from list of pre-built contests, (b) Define custom fields for contest, (c) Edit contest legal copy & disclaimer(s), (d) Define length of time for contest, and (e) Enter prizes for contest. Or choose Custom Content—Allow users to upload custom content (games, animation, etc.) and reference where in FLASH container content will appear (intro, main section, outro, and the like).

In Step 430, the sender then instructs that the email is to be merged and sent. In response, the data chosen by the sender is merged, in Step 440, and sent as a FLASH (or other equivalent web-animation and interface software) email to the indicated recipients. In this regard, a custom preloader will be created to load all of the custom content. This preloader performs the following tasks: (a) Checks client browser and email client to determine user browser and version and FLASH plug-in version. If the user's browser or email client does not have the required version of the FLASH plug-in installed, the user is notified and prompted to install FLASH; (b) Preloads the shell data (bytes) to a predetermined percentage; and (c) Directs the FLASH shell file to externally load variables and content from the database 18 and server 10. This includes dynamic copy/text, audio, video, server-side FLASH files, shopping carts.

A library of AS (actionscript) files is created for use of various components (MP3 player, video player, effects, and the like) and published through the admin tool on the server 10. Multimedia files (MP3 s, FLV video, images, and the like) are uploaded to the server 10 and a campaign manager launches a graphical tool that allows users to pick and choose components, multimedia bits, compose menus, move images on the page, enter text and create effects from an effects library.

At this point, the campaign manager (sender) saves all of the reference data of the components relevant to the campaign that was created in the database 18. When the email campaign is launched, each individual HTML email file contains a reference address to the embedded SWF. The emails are sent individually, so as they go out, a single variable (Unique ID) is printed in the HTML object and embed tags surrounding the FLASH SWF player.

In Step 450, the recipients retrieve and view the email. The recipients may also interact with the various interactive FLASH (or other equivalent web-animation and interface software) modules. The usage data is tracked and sent back to the server 10 where it is stored in a central database 18 in Step 460. According to one embodiment, the data tracked includes number of time the received email is viewed/opened, the number of times it is opened, the length of time it is viewed, and the like. This includes subsections that are streamed through the FLASH file: MP3 audio; FLV and QT video; copy that is read; games played; results of games; contest points; and the like. In addition, all forward activity is tracked: personal text data for recipients that forward to new recipient; whether the forwarded mails are viewed and how many are viewed, how often, and the like. Notably, the information that was uploaded into the database back in Step 420 can be modified after the web-animation and interface enabled-email was sent, or even after the email has been opened by a recipient. In this manner, the information in the web-animation and interface enabled-email can be updated as required or desired.

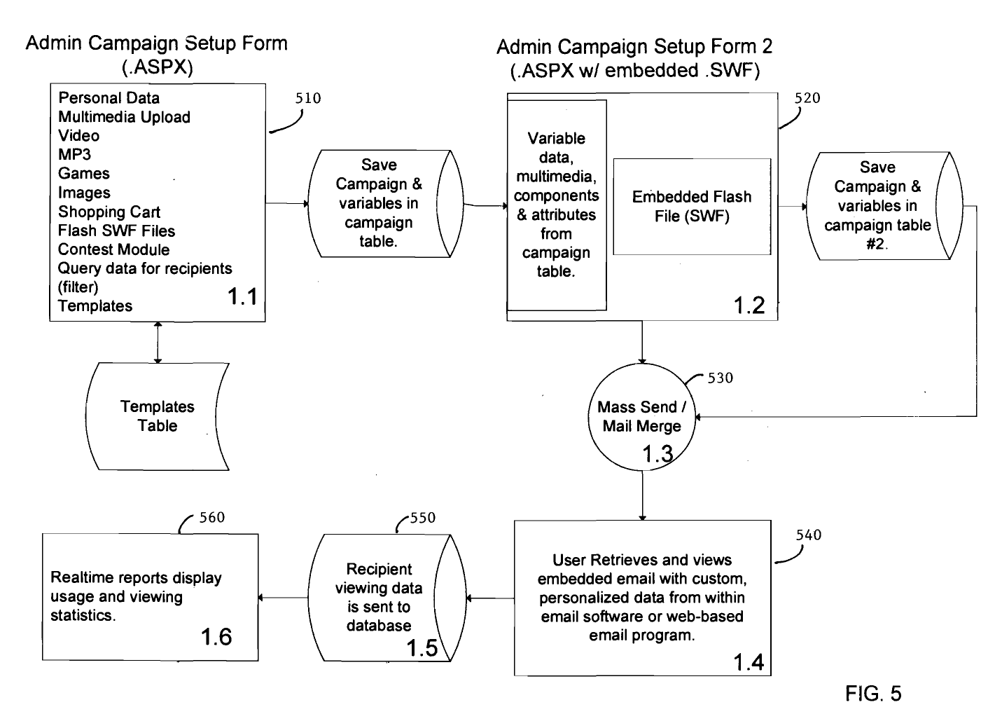

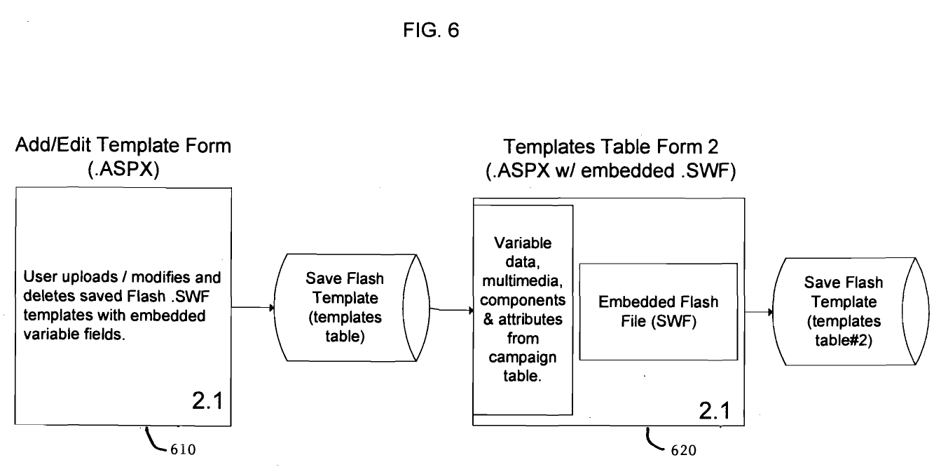

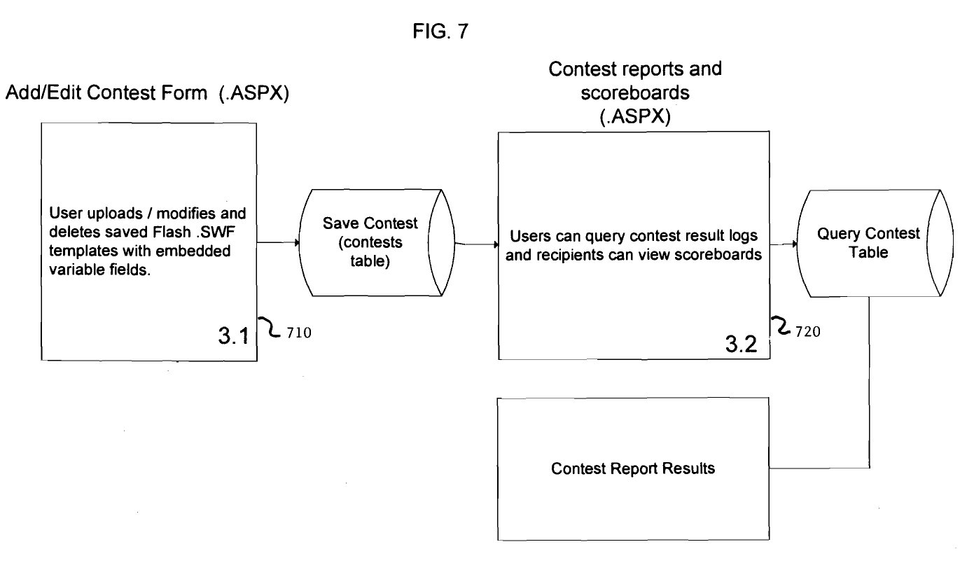

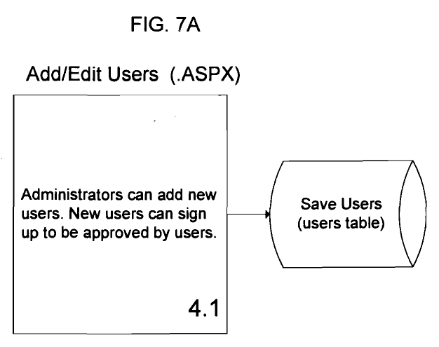

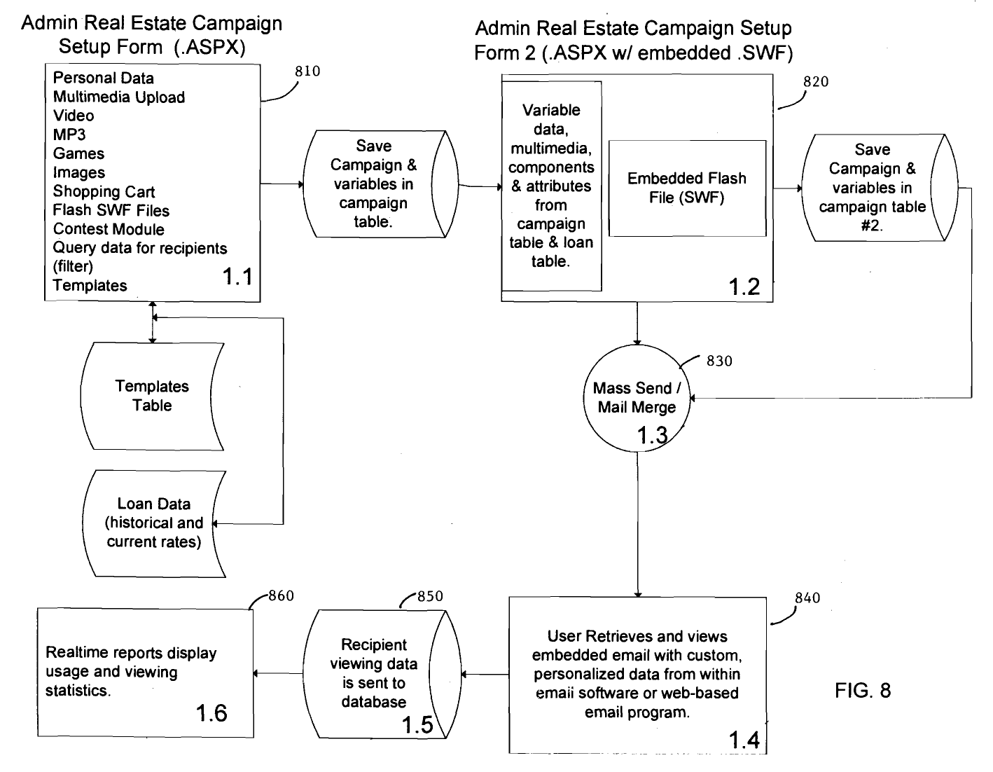

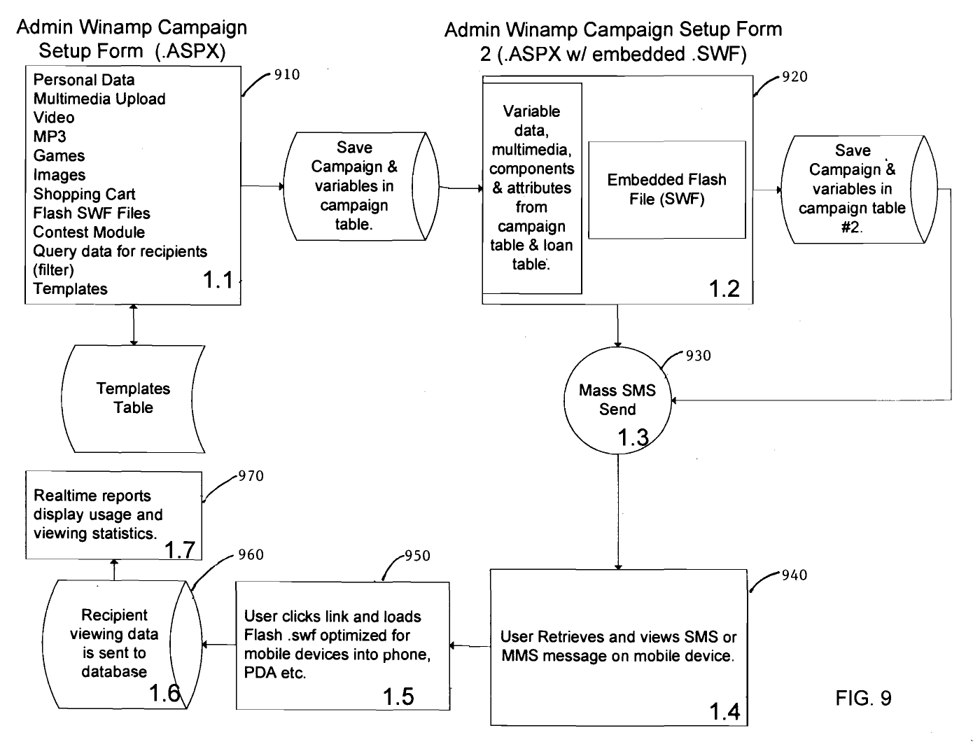

FIG. 5 is a more detailed flow diagram of the various processes of FIG. 4. According to one embodiment of the invention, FIG. 6 illustrates system functionality that enables control (e.g., add/delete/edit) of a template form. According to one embodiment of the invention, FIG. 7 illustrates system functionality that enables administration of contests. According to one embodiment of the invention, FIG. 7A illustrates system functionality that enables administration of users fields. According to another embodiment of the invention, FIG. 8 is similar to the process of FIG. 5, but includes functionality to analyze loan details. FIG. 9 is similar to the process of FIG. 5, but is specific to the use of mobile devices to retrieve and view the emails.

Referring again to FIG. 5, in Step 510, a template is shown in which the advertiser/sender chooses a desired input module and uploads the relevant file type or template for use with the data (data, media or SWF file). Otherwise stated, a backend user upload multimedia, pre-made FLASH (or other equivalent web-animation and interface software) SWF files, images and input personal information (sender contact info, messages, etc.) into the SQL database to set up a new campaign or modify an existing campaign. A FLASH (or other equivalent web-animation and interface software) template is embedded with fields and some load variable commands and rendered as a SWF file. The user has the option to save the campaign and variable data. Additionally, this template can be used to query a SQL database in order to set up “filters” of recipients.

Step 520 illustrates a template in which an ASPX .NET menu on the left and an embedded FLASH (or other equivalent web-animation and interface software) file. Users can drag and drop data, components, images, multimedia files, and the like, from the left menu directly into the embedded FLASH SWF file. Then users can arrange the items on the page, visually build menus for the FLASH file and set orders of items appearing in the SWF file. The output file can then be saved, reviewed, modified, and/or sent as a compiled SWF file.

In Step 530, the sender executes the mail merge in which the relevant campaign data and unique campaign IDs (i.e., identifiers) are stamped in each recipient's data record; the email data is groomed, and each email is sent using the appropriate optimized output file. In this regard, the server 10 reviews the rules set up by the administrator for each device and determines the correct email output to send based on the rules. Preferably, the mass mailing is sent through ASPX .NET, which merges all campaign data and personalized information from the SQL database. SWF file is embedded into an HTML.

In Step 540, a user retrieves and views embedded email with custom, personalized data from within an email software or web-based email program. The devices/applications for viewing the email or distributed rich media may include desktop computer email, mobile phones, handheld computers, PDAs, regular web presentation, WINAMP plug in, and the like. The recipient retrieve data from the SQL database through FLASH Remoting using “sendAndLoad” or similar function and customized ASPX .NET files. As a user chooses data to view (audio, video, games, other content), the data is retrieved and streamed from the database 18 on demand.

In Step 550, as users view different pieces of content or areas of the FLASH (or other equivalent web-animation and interface software) email, tracking data is sent to the database 18 through ASPX/FLASH Remoting and stored for statistical analysis. In Step 560, real-time reports allow users to review usage statistics for each specific campaign as well as comparisons and overviews of multiple campaigns in the system.

Referring now to FIG. 6, at Step 610, users control all the templates in the system. Fields that have been included in the table (e.g., MP3, streaming MP3, Sender Name, Sender, Address, Contest flag, and the like) can be activated for each template. Step 620 features an ASPX .NET menu on the left and an embedded FLASH (or other equivalent web-animation and interface software) file. Users can drag and drop data, components, images, multimedia files, and the like from the left menu directly into the embedded FLASH SWF file. When these data, components, images, and/or multimedia files are “dragged and dropped” into the template, the system generates a back-end script file (e.g., XML) that corresponds to the “dragged and dropped” data, components, images, and/or multimedia files in the template. In one preferred embodiment, users can then arrange the items on the page, visually build menus for the FLASH file, and set orders of items appearing in the SWF file. These can then be saved and/or sent as a compiled SWF file.

Referring now to FIG. 7, at Step 710 to enables administration of contests. The contest module allows for three kinds of contests: (a) “enter to win” drawings; (b) “scratch-n-win” instant prize giveaways; and (c) competitive contests. The competitive contests track user activities and award points accordingly. At the end of a pre-determined time period, recipients with the most points win prizes. These are exemplified by “Send-to-a-friend” competitions. The contest module allows tracking of the number of recipients that have forwarded the web-animation and interface-enabled email through a template and the forwarded recipients that have viewed the web-animation and interface-enabled email. In this case, the highest number of logged views would determine the winner. At Step 720, the contest module features two types of reports: (a) usage reports (these can only be seen by administrative users); and (b) up-to-the-minute scoreboards. These can be seen by all recipients and track the users who are in the top 100 spots through the duration of a contest.

Referring now to FIG. 8, at Step 810 a template is shown that enables backend users to upload multimedia, pre-made FLASH SWF files, images and input personal information (sender contact info, messages, and the like) into the SQL database to set up a new campaign or modify an existing campaign. Furthermore, this template can be used to query an SQL database in order to set up “filters” of recipients. Moreover, users can add loan data and calculators for existing loan customers. This includes functionality to analyze existing loan details (APR, monthly payment, FICO scores, and the like) and compare them to current loan rates. This data can then be merged into the email and streamed through the web-animation and interface-enabled email.

At Step 820, a template is shown that features an ASPX .NET menu on the left and an embedded FLASH (or other equivalent web-animation and interface software) file. Users can drag and drop data, components, images, multimedia files, and the like from the left menu directly into the embedded FLASH SWF file. Additionally, users can arrange the items on the page, visually build menus for the FLASH (or other equivalent web-animation and interface software) file, and set orders of items appearing in the SWF file. These can then be saved and/or sent as a compiled SWF file. Preferably, at Step 830, the Mass Mail is sent through ASPX .NET, merging all campaign data and personalized information from SQL database. In this embodiment, the SWF file is embedded into an HTML

At Step 840, data is retrieved from SQL database through FLASH Remoting using “sendAndLoad” or similar function and customized ASPX .NET files. As a user chooses data to view (audio, video, games, other content), the data is retrieved and streamed from the database 18 on demand. At Step 850, as users view different pieces of content or areas of the web-animation and interface-enabled email, tracking data is sent to the database 18 through ASPX/FLASH Remoting and stored for statistical analysis. At Step 860, real-time reports allow users to review usage statistics for each specific campaign as well as comparisons and overviews of multiple campaigns in the system.

Referring now to FIG. 9, at Step 910, a template is shown that enables backend users to upload multimedia, pre-made FLASH SWF (or other equivalent web-animation and interface software) files, images and input personal information (sender contact info, messages, etc.) into the SQL database to set up a new campaign or modify an existing campaign. Additionally, this template can be used to query an SQL database to set up “filters” of recipients. This data can then be merged into the SMS blast and streamed through the web-animation and interface-enabled email. At Step 920, a template is shown that features an ASPX .NET menu on the left and an embedded FLASH (or other equivalent web-animation and interface software) file. Users can drag and drop data, components, images, multimedia files, and the like from the left menu directly into the embedded FLASH SWF (or other equivalent web-animation and interface software) file. Then users can arrange the items on the page, visually build menus for the FLASH (or other equivalent web-animation and interface software) file, and set orders of items appearing in the SWF file. These can then be saved and/or sent as a compiled SWF file.

At Step 930, a Mass SMS/MMS broadcast is sent through ASPX .NET, merging all campaign data and personalized information from SQL database. The SWF file is embedded into a WML (Wireless Markup Language) or HTML file or can be optionally sent as an executable. At Step 940 a user selects a link in SMS or MMS message sent to mobile device. The link opens up a mobile browser window which loads WML or HTML file from the server 10. The WML or HTML file contains an embedded version of a SWF file appropriate to the specific mobile device.

At Step 950, data is retrieved from SQL database through FLASH Remoting using “sendAndLoad” or similar function and customized ASPX NET files. As a user chooses data to view (audio, video, games, other content), the data is retrieved and streamed from the database 18 on demand. At Step 960, as users view different pieces of content or areas of the web-animation and interface-enabled email, tracking data is sent to the database 18 through ASPX/FLASH Remoting and stored for statistical analysis. At Step 970, real-time reports allow users to review usage statistics for each specific campaign as well as comparisons and overviews of multiple campaigns in the system.

Referring now to the WINAMP Plug-in Module (or other equivalent multimedia software), in a preferred embodiment the module is an executable (EXE) file that is installed by recipients on computers having a Windows operating system and WINAMP software installed thereon. In one embodiment, the plug-in module allows FLASH SWF (or other equivalent web-animation and interface software) files to be synchronized with the WINAMP player (or other equivalent multimedia software). These SWF files are loaded across the Internet from a server 10 into the recipient's plug-in animation interface software. This plug-in module transmits data from the recipient's WINAMP software to the plug-in module, which is sent to the server 10 and stored in a database 18. Examples of data sent from WINAMP to the plug-in module (and the database 18) include: song names, artist names, and date/time information that songs are listened to by recipients. In addition, timing data is sent to the plug-in module that allows synchronized actions to occur in the plug-in.

When an email campaign is launched, one or more individual HTML email files are sent to each recipient on the email list containing their own embedded objects that each correspond to the individually embedded media files, such as SWF files. The emails are sent individually (i.e., serially). Accordingly, as the emails are sent, the variables (data) are printed in the HTML object and embedded tags (using the Actionscript function FLASHvars) surrounding the FLASH SWF player. In one preferred embodiment, when a user opens the HTML email, FLASH loads the Unique ID (i.e., identifier) variable from FLASHvars, and then sends a server-side query on the database 18 to load the relative information. The query returns all of the copy and content relevant to the campaign and the individual user.

An alternate preferred embodiment involves the addition of a “FLASH Remoting” server 10. This is a server 10 that is off-the-shelf, for instance MACROMEDIA® and several other competing products, that are used to pass data to and from the FLASH (or other equivalent web-animation and interface software) application from a database 18 (such as MICROSOFT SQL) containing the variables.

In all embodiments, the detection “sniffer” does not require a scripting language, rather the detection process takes place within email headers, HTML, and the one or more FLASH (or other equivalent web-animation and interface software) actionscripts. Specifically, when a user opens the HTML email, a custom client-side “sniffer” automatically detects what kind of capabilities the email client has and loads content appropriately. Notably, if a user's email client does not support FLASH, an optional HTML email is shown with an HTTP query string link to a dynamic middleware file with embedded FLASH. This string is placed on a GIF or JPG image. This file could be HTML, PHP, ASP, ASPX, JSP, or the like. The query string transfers the variable(s) from the HTML email so the embedded FLASH .SWF can read them. The browser loads the FLASH shell file and uses the variable to load all of the relevant content into the FLASH file. Continuing, if a user's email client does not support HTML, an HTTP query string is shown with alternative text copy. When the user clicks on this link, a browser window is launched (the process is identical to selecting the GIF or JPG image in an HTML email).

Another alternate preferred embodiment uses an advanced detection system to automatically send different types of HTML code based specifically on the recipient's email address. For instance, if a recipient uses YAHOO, AOL, or MAIL.com, an HTML only version will be sent with a query string image and link. If a user uses MAC.com (which supports embedded FLASH), the full FLASH experience is sent. A comprehensive database stores rules for each of the different major web email providers with the current state of support level for each email service, program, or platform (what type of files the email service supports: FLASH .SWF, HTML or text only). When a campaign is launched, the recipient email addresses are scrubbed against the rules database and the appropriate version of the campaign is sent to each address based on the rules settings for the applicable service.

Referring again to FIG. 4, another alternate preferred embodiment replaces the above-described Steps 4, 5, and 6, which take place on the client side, with the detection of the major email hosts on the server side. This embodiment has an administration module that enables an administrator to add email clients. For instance, GOOGLE launches GMAIL. Our programmers decide the best solution for the GMAIL wrapper, enter the admin tool, add GMAIL as a new email client and choose one of 4-6 configurations for sending to GMAIL.

In still another alternate preferred embodiment, (with reference to FIG. 4) at Step 5, a server-side application recompiles a FLASH .SWF file on-the-fly. In one embodiment, this server-side application is created in Microsoft Visual Studio or an equivalent. This tool resides on the server 10 and has the following capabilities: (a) convert Video formats such as QUICKTIME and MPEG videos to FLV files on-the-fly; (b) embed images and copy into a FLASH file and output as a .SWF; (c) automatically hardcode queries, code snippets, file references and dynamic links inside the FLASH SWF file. In Step 6, the unique variables are embedded inside the SWF file or email header as the emails are sent. In this case, there are no variables printed in the embed/object tags.

In another aspect of an alternate preferred embodiment, graphics, audio, and video may be removed and/or transformed so that the output file may be viewed by lower memory devices, (e.g., PDAs, cellphones, or handheld computers). In this step, the personalized digital media output are placed in the system storage device for retrieval and access by the recipient or other third parties. In another step, the recipient are sent a link to access and send the personalized digital media file to third parties. In a third step, a hard-coded executable are created to enable FLASH (or other equivalent web-animation and interface software) files to be viewed directly in email on mobile devices.

According to one embodiment, the generation of the final email format uses the tool described above with reference to Step 5. In still another embodiment, multiple versions of a campaign are manually output and optimized for different formats and for referencing which formats are specific to which version of the campaign (e.g., Version 1A=broadband email; Version 1B=dialup email; Version 2A=Pocket PC; Version 2B=Smartphone).

One of ordinary skill in the art will appreciate that not all embodiments of this invention have all these components and may have other components in addition to, or in lieu of, those components mentioned here. Furthermore, while these components are viewed and described separately, various components may be integrated into a single unit in some embodiments.

The various embodiments described above are provided by way of illustration only and should not be construed to limit the claimed invention. Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A multimedia-enabled, individually-customizable email and rich media delivery system for providing increased response ratios, the system comprising:
a web-animation and interface-enabled email delivery system that facilitates transmitting emails to target devices using a web-animation and interface software as a front end user interface application;
wherein the emails and rich media are generated in mass via a single email generation process in a customizable manner that enables individualized email tailoring to each recipient, and wherein portions of the emails or distributed rich media are personalizable and capable of delivering sound, text, graphics, video, individualized personal data or combinations thereof via.

2. The system of claim 1, wherein the web-animation and interface software is FLASH.

3. The system of claim 1, wherein the web-animation and interface-enabled email opens and plays directly from the email application, rather than requiring a separate browser to be launched.

4. The system of claim 1, wherein the system further comprises a sniffer mechanism that assists in determining what applications are supported by a target recipient's email application, thereby enabling emails to be formatted and transmitted as a web-animation and interface-enabled email that is in a format which is likely to be supported by the target recipient's email application.

5. The system of claim 1, wherein the system includes multiple web-animation and interface-enabled email formats, enabling the system to select a corresponding web-animation and interface software format that is likely to be supported by the recipient's email application.

6. The system of claim 1, wherein a web-animation and interface-enabled email that is delivered to a recipient contains various interactive components that may be interacted with by the email recipient.

7. The system of claim 1, wherein the interactive components include MP3 audio files, video files, games, shopping carts, and combinations thereof.

8. The system of claim 1, wherein recipient interaction with one or more of these interactive components is trackable.

9. The system of claim 8, wherein the tracked recipient interaction is transmitted to a central database and stored in association with the interacting recipient.

10. The system of claim 1, wherein the web-animation and interface-enabled email enables promotion of various contests.

11. The system of claim 10, wherein one of the various contests is a competitive contest that tracks user activities with the web-animation and interface-enabled email and awards points accordingly.

12. The system of claim 10, wherein at the end of a predetermined period in the competitive contest, the recipient with the most points win one or more prizes.

13. The system of claim 10, wherein activities that award points to recipient is predetermined by a sender of the web-animation and interface-enabled email.

14. The system of claim 1, wherein the system further includes a plug-in module that enables web-animation and interface-enabled rich media email to be synchronized with a multimedia player on a recipient's email application.

15. The system of claim 14, wherein the multimedia player on the recipient's computer email application is WINAMP.

16. The system of claim 14, wherein the plug-in module enables a sender of the web-animation and interface-enabled rich media email with an ability to push customized content, directly through WINAMP.

17. The system of claim 16, wherein the content includes messages, advertising, games, MP3 audio files, video files, and combinations thereof.

18. The system of claim 14, wherein the plug-in module tracks recipient listening habits, including the types of songs, artists, listening dates, listening times, and combinations thereof.

19. A multimedia-enabled, customizable email and rich media delivery system, the system comprising:
an email management server, wherein the server is operatively connected to a mass storage device;
web-animation and interface-enabled email and rich media delivery sender device; wherein the sender device enables a sender to create and send web-animation and interface-enabled email in conjunction with the email management server;
one or more recipient devices connected to the sender device and the email management server via a data communications network, wherein the one or more recipient devices receive the web-animation and interface-enabled emails;
wherein the emails and distributed rich media are generated in mass via a single generation process in a customizable manner that enables individualized email and rich media tailoring to each recipient, and wherein portions of the emails are personalizable.

20. The system of claim 19, wherein the server includes one or more software modules for providing different creation, management, or delivery functionalities.

21. The system of claim 20, wherein the one or more software modules include upload/selection module, a multimedia management module, an email formatting module, a query response module, a tracking module, or combinations thereof.

22. The system of claim 21, wherein the upload/selection module enables an administrator or sender to create, upload, or select stored web-animation and interface software templates, multimedia files, personal messages, sender data, or combinations thereof, for generation of the web-animation and interface-enabled emails.

23. The system of claim 21, wherein the email formatting module enables generation appropriate email output based on selected or uploaded data.

24. The system of claim 21, wherein the multimedia management module assists with management of multimedia associated with the web-animation and interface-enabled emails and distributed rich media.

25. The system of claim 21, wherein the query response module receives data requests from a recipient viewing and interacting with the web-animation and interface-enabled emails and distributed rich media, retrieves the appropriate content, and streams the content to the recipient.

26. The system of claim 21, wherein the tracking module receives and tracks interactions with the web-animation and interface-enabled emails and distributed rich media, including whether emails and distributed rich media have been viewed, whether emails have been forwarded, whether interactive components of the FLASH campaign have been interacted therewith, and combinations thereof.

27. The system of claim 19, wherein the emails and distributed rich media enable delivery of sound, text, graphics, video, or combinations thereof.

28. The system of claim 19, wherein the data communications network is a public Internet.

29. The system of claim 19, wherein the recipient devices have a web-animation and interface-enabled plug-in module installed for enabling display of web-animation and interface software content.

30. The system of claim 28, wherein the web-animation and interface-enabled plug-in module is a FLASH player.

31. The system of claim 19, wherein the mass storage device comprises a disk drive which enables storing information used by the server.

32. The system of claim 19, wherein the mass storage device maintaining different web-animation and interface-enabled templates that are selectable by the sender to facilitate generation of the web-animation and interface-enabled emails and distributed rich media.

33. The system of claim 19, wherein the mass storage device includes various multimedia components that are selectable by the sender to facilitate generation of the web-animation and interface-enabled emails and distributed rich media.

34. The system of claim 33, wherein the selecting of the multimedia components is performed using drag and drop functionality.

35. The system of claim 19, wherein the mass storage device stores one or more rules in a rules database that are useable by the email formatting module for determining an email output format to be used in transmitting the emails to indicated recipients.

36. The system of claim 19, wherein the sender and recipient devices are connectable to the data communications network using a telephone connection, a satellite connection, a cable connection, a radio frequency communication, a wired data communication mechanism, a wireless data communication mechanism, or combinations thereof.

37. The system of claim 19, wherein the sender and recipient devices comprise a personal computer, a hand-held personal computer, a television set top-box combination, a personal digital assistant, a mobile phone, or other comparable consumer electronics device.

38. The system of claim 19, wherein a platform to which the web-animation and interface plug-in module installs, is selected from the group consisting of LINUX, UNIX, MICROSOFT WINDOWS, MACINTOSH, WINDOWS MOBILE, WINDOWS CE, POCKET PC, SMARTPHONE, IRIVER, and other mobile platforms.

39. The system of claim 19, wherein the data communications network is selected from the group consisting of: digital cable interactive television networks, fiber-optic networks, interactive satellite television networks, or combinations thereof.

40. The system of claim 19, wherein the server is accessible through the use of a secure login and password.

41. The system of claim 19, wherein the web-animation and interface-enabled emails and distributed rich media contain unique variable identifiers that determine proper components and data for each email recipient.

42. The system of claim 41, wherein the proper components and data for each email and distributed rich media recipient includes personalized data and multimedia components.

43. The system of claim 19, wherein a unique identifier is sent across the data communications network to the server and a query is performed on the mass storage device in response to an email and distributed rich media recipient viewing the web-animation and interface-enabled email.

44. The system of claim 19, wherein the mass storage device accesses a unique identifier number and returns corresponding data to the recipient's web-animation and interface-enabled email.

45. The system of claim 44, wherein the corresponding data includes personalized text data, MP3 audio data, video data, and combinations thereof.

46. The system of claim 19, wherein a scripting language pre-loader compiles data in a recipient's web-animation and interface software plug-in module, and displays the data as specified by a sender of the web-animation and interface-enabled email and distributed rich media.

47. The system of claim 19, wherein files that are useable with a template include multimedia files and web-animation and interface-enabled modules.

48. The system of claim 19, wherein the system enables an administrator to securely login to the system and view, add, delete, and modify modules and content.

49. The system of claim 19, wherein the system enables an administrator to assign access rights for various modules and components to one or more clients.

50. The system of claim 19, wherein the system enables an administrator to manage, edit, and delete users and user security levels.

51. The system of claim 19, wherein the system enables an administrator to add, delete, and edit global and user-specific reports and contest types.

52. The system of claim 19, wherein the system enables an administrator to add, delete, edit, and review individual campaign files and results.

53. The system of claim 19, wherein the system further comprises an email grooming system, wherein the email grooming system examines an email address list to verify that all email addresses contain proper format and that no duplicate addresses exist.

54. The system of claim 53, wherein the email grooming system prevents an email recipient from using the system for nefarious practices.

55. The system of claim 19, wherein the server includes a secure login module, an upload module, an input handler module consisting of temporary data storage, a security checking module, a query response data module, a multimedia management module, a file error checking module, an update test module, a compression module, or combinations thereof.

56. A method for creating a multimedia-enabled, customizable email and distributed rich media delivery system, the method comprising:
selecting a web-animation and interface software template for an email and distributed rich media campaign, wherein the template includes embedded merge fields for merging campaign data to generate a customized email campaign;
uploading email and distributed rich media campaign content to a server, wherein email campaign content includes personalized data and multimedia components;
storing the template, personalized data, and multimedia components for the customized campaign, wherein the template, personalized data, and multimedia components are modifiable after the campaign has been sent;
determining, based on a comparison of a recipient email address and rules stored in a rules database, what web-animation and interface software a recipient email application on a recipient device is projected to support;
generating emails formatted in the projected web-animation and interface software;
transmitting the emails and distributed rich media to recipient devices, wherein each email has a unique identifier associated with a corresponding email recipient;
in response to a recipient viewing a web-animation and interface-formatted email or distributed rich media, transmitting the recipient's unique identifier to the server; and
retrieving individually personalized email and distributed rich media campaign content to the email recipient for merging into a template.

57. The system of claim 56, wherein features of the customized campaign include the placement of text, menu titles to be included, video and audio content and order, type of games, and combinations thereof.

58. A multimedia-enabled, customizable content delivery system, the system comprising:
a management server, wherein the server is operatively connected to a mass storage device;
web-animation and interface-enabled content delivery sender device, wherein the sender device enables a sender to create and send content in conjunction with the management server;
one or more recipient devices connected to the sender device and the management server via a data communications network, wherein the one or more recipient devices receive the content;
wherein the content is generated in mass via a single generation process in a customizable manner that enables individualized content tailoring to each recipient, and wherein portions of the content is personalizable.

59. The system of claim 58, wherein the content is rich media.

60. The system of claim 58, wherein the content is delivered to a recipient device in response to a user interacting with an email or an item included within the email.

61. The system of claim 58, wherein the content is delivered to a recipient device in response to a user interacting with a Short Message Service message or an item included within the Short Message Service message.

62. The system of claim 58, wherein the content is delivered to a recipient device in response to a user interacting with a Multimedia Message Service message or an item included within the Short Message Service message.
